(19) United States
(12) Patent Application Publication
(10) Pub. No.: US 2014/0095703 A1
(43) Pub. Date: Apr. 3, 2014

(54) SYSTEM FOR MANAGING AND MONITORING CLOUD HOSTS AND METHOD THEREOF

(71) Applicant: DELTA ELECTRONICS, INC., Taoyuan County (TW)

(72) Inventors: Jui-Tsung HUNG, Taoyuan County (TW); Ping-Hui HSU, Taoyuan County (TW)

(73) Assignee: DELTA ELECTRONICS, INC., Taoyuan County (TW)

(21) Appl. No.: 14/020,154

(22) Filed: Sep. 6, 2013

(30) Foreign Application Priority Data
Sep. 28, 2012 (TW) 101135838

(51) Int. Cl. H04L 12/26

(52) U.S. Cl. CPC H04L 43/04
USPC 709/224

(57) ABSTRACT

A system for managing and monitoring cloud hosts and method thereof is disclosed. The monitoring system comprises a cloud host and a plurality of monitoring servers. Each monitoring server is respectively used for processing data of different categories. The cloud hosts detect each host status of their own for generating a plurality of status data. The plurality of status data respectively records the data of different categories. Next, the cloud hosts respectively transfer the status data of different categories to corresponding monitoring servers. The plurality of monitoring servers save the status data of the cloud hosts by the categories, and respectively execute the following processing steps. Thus, the burden of the single server is reduced because the status data processing is shared.

### BACKGROUND OF THE INVENTION

1. Field of the Invention

The present invention relates to a monitoring system and monitoring method, in particular further relates to a monitoring system and a monitoring method for avoiding the monitoring mechanism from failing when a single server or a single database in the cloud data center fails.

2. Description of Related Art

Generally speaking, a cloud data center is equipped with various kinds of hosts, such as Physical Machine (PM), Virtual Machine (VM), switches, routers, uninterruptible power supplies, UPSs, firewalls etc. for respectively processing different data.

In order to manage and monitor the status of the data center at ease, the administrators typically install sensors by means of hardware or software in the host for monitoring the all kinds of host data, for example, temperatures, humidity, fan rates, CPU, memory, network status, hardware capacity etc. The detected data is periodically reported and saved in a database of the data center. The administrators further access the database for monitoring all kinds of host data in the data center.

Currently, the data centers are connected to each host via single monitoring server and database. Thus, each host respectively detects the host data of its own, the single monitoring server monitors the host data, and the single database saves the host data. Though, the host is required to detect the data of its own continuously, and periodically reports the data to the monitoring server, and saves the data in the database. Accordingly, when the quantity of the hosts in the cloud data center is large, the report frequency is too high, or the data traffic reported at the same time is too large, the monitoring server or the database may be overloaded which results in data loss. As mentioned above, typically cloud data center usually installs single monitoring server and database. Accordingly, when the monitoring server or database is damaged, the monitoring mechanism of the cloud data center fails too.

Further, when the quantity of the hosts in the cloud data center is large, the stotage space of the database may become insufficient, administrators have to ad-hoc add the database capacity which is inconvenient to operate.

### SUMMARY OF THE INVENTION

The objective of the present invention is to provide a system for managing and monitoring cloud hosts and method thereof. The distributed plurality of monitoring servers are used for respectively monitoring, saving and processing corresponding data so as to assure that when single server or single database damages, the monitoring mechanism of the cloud data center does not fail.

In order to achieve the above objective, the present invention provides a monitoring system comprising a cloud host and a plurality of monitoring servers. Each monitoring server respectively is used for processing data of different categories. The cloud hosts detect each host status of its own for generating a plurality of status data. The plurality of status data respectively records data of different categories. Next, the cloud hosts respectively transfer the status data of different categories to the corresponding monitoring server. The plurality of monitoring servers save the status data of the cloud hosts by the categories, and respectively execute following processing steps.

Compare with related art, the present invention offers advantage is that a plurality of monitoring servers are allocated according to a predetermined rule of a cloud data center. Each monitoring server respectively monitor, save and process the data of different categories of the cloud hosts, such as CPU, hard drive, memory, traffic etc. typically, a single servers has to monitor and process all data of all cloud hosts which generates too much loading for the server to process. With the present invention, the problem occurred to a traditional single server is solved as a result.

Further, traditional cloud data centers save all data of all cloud hosts via single database. Accordingly, when the quantity of the cloud hosts is too many, the saving space of a database may be insufficient, and the capacity has to be upgraded. The present invention allows each monitoring server to play the role of a database. In other words, the quantity of the databases equals to the quantity of the monitoring server, which effectively resolve the insufficient saving space problem of a single database.

The system of the present invention respectively monitors, save and process data of corresponding categories via multiple monitoring servers. As a result, when a monitoring server is damaged, operation of the other monitoring servers is not affected. The system is required to establish a new monitoring server, or leading the cloud hosts to back-up monitoring servers. With the technical solution, the impact on the cloud data center when monitoring servers fail is reduced. Also, each monitoring server is informed which data categories assigned to other monitoring servers. Therefore, when a user inquires specific data of the cloud hosts, the inquiry is effective given the monitoring server are distributed.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a system architecture diagram of the first preferred embodiment according to the present invention;

FIG. 2 is a timing schematic diagram of the first preferred embodiment according to the present invention;

FIG. 3 is a cloud host block diagram of the first preferred embodiment according to the present invention;

FIG. 4 is a host storage pool block diagram of the first preferred embodiment according to the present invention;

FIG. 5 is a monitoring server block diagram the first preferred embodiment according to the present invention;

FIG. 6 is a monitoring flow chart of the first preferred embodiment according to the present invention;

FIG. 7 is a monitoring flow chart of the second preferred embodiment according to the present invention;

FIG. 8 is a system architecture diagram of the second preferred embodiment according to the present invention;

FIG. 9 is an inquiring flow chart of the first preferred embodiment according to the present invention; and

FIG. 10 is a system architecture diagram of the third preferred embodiment according to the present invention.

### DETAILED DESCRIPTION OF THE INVENTION

Embodiments are provided in the following in order to further detail the implementations of the present invention in the summary. It should be noted that objects used in the diagrams of the embodiments are provided with proportions, dimensions, deformations, displacements and details are examples and the present invention is not limited thereto and identical components in the embodiments are the given same component numbers.

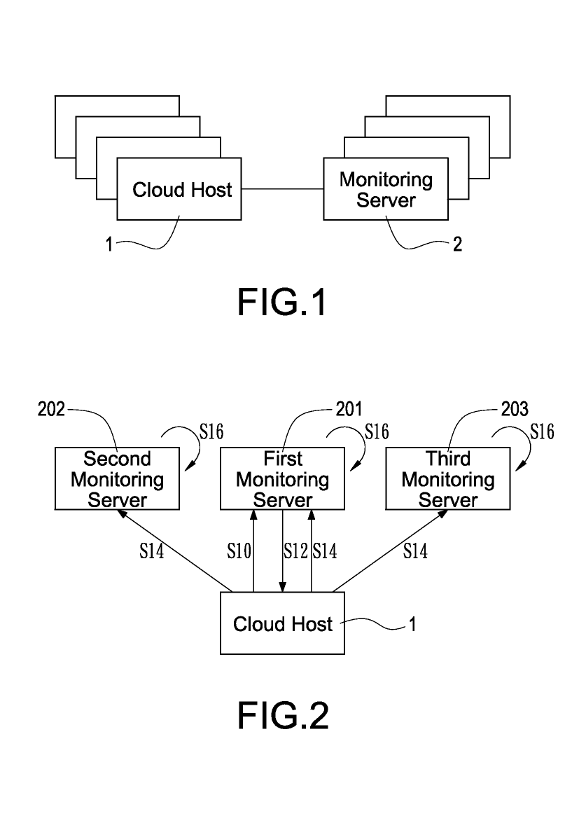

FIG. 1 is a system architecture diagram of the first preferred embodiment according to the present invention. As shown in the diagram, the monitoring system of the present invention comprises at least a cloud host 1 and a plurality of monitoring servers 2, and the plurality of monitor servers 2 respectively connect to the at least a cloud host 1. In the present invention, the plurality of monitoring servers 2 are used for monitoring the host status of at least a cloud host 1, and saving as well as processing the status data of at least the cloud host 1. For illustration, in the following description, the cloud hosts 1 is used as the example and the cloud hosts 1 is referred as the host 1.

The host 1 and the monitoring server 2 are regarded as a node in the cloud data center, which are implemented with a Physical Machine (PM) or a Virtual Machine (VM), and are not limited thereto. Further, the monitoring system assigns the role of the monitoring server 2 to any or multiple nodes. Accordingly, when the VM is implemented, the same PM both acts the roles as the host 1 and the monitoring server 2. In other words, the host 1 and the monitoring server 2 are not required to be in the PM, and not necessarily to exist alone. A PM acts as multiple roles, and accordingly the system is flexible in operations.

FIG. 2 is a timing schematic diagram of the first preferred embodiment according to the present invention. In the present invention, as the monitoring system assigns roles to a plurality of nodes, to enable the plurality of nodes to be the plurality of monitoring servers 2, the plurality of monitoring servers 2 are categorized. Thus, a plurality of the monitoring servers 2 respectively monitor the data of different categories in the host 1. In the embodiment shown in the FIG. 2, the plurality of monitoring servers 2 are demonstrated by a first monitoring server 201, a second monitoring server 202 and a third monitoring server 203. Nonetheless, the quantity of the plurality of monitoring servers 2 depends on the category status and is not limited to three units.

For example, the first monitoring server 201 is used for monitoring the CPU data of the host. The second monitoring server 202 is used for monitoring the hard drive data of the host 1. The third monitoring server 203 is used for monitoring the network traffic of the host 1 etc. Thus, if the cloud data center has a thousand hosts, the CPU data of the thousand hosts is monitored by the first monitoring server 201, the hard drive data is monitored by the second monitoring server 202, and the network traffic data is monitored by the third monitoring server 203.

In addition, the monitoring system can further categorize the data of the host 1 via large quantity of the monitoring server 2. For example, the first monitoring server 201 monitors the CPU usage, the second monitoring server 202 monitors CPU temperature, and the third monitoring server 203 monitor CPU fan rates etc. The three monitoring servers 201-203 collectively monitor the CPU data of the host 1. Nonetheless, the above mentioned is used as a preferred example of the present invention and should not be limited thereto.

As shown in FIG. 2, when the host 1 is enabled, the host 1 performs the outbound multicast (step S10) and simultaneously sends packets to all the monitoring servers 2 in the monitoring system. Next, the first monitoring server receives the packets (for example, the first monitoring server 201) and accepts the registration of the host 1. In addition, the host 1 receives the first monitoring server 201 the allocation data replied via the unicast upon the registration is completed (step S12). It should be noted that the host 1 and the plurality of monitoring servers 2 each has a Internet Protocol (IP) address and transfers data via the wired/wireless network. Generally speaking, when the host 1 sends packets, the first monitoring server 201 which has the IP address nearest to the IP address of the host 1 first receive the packets. For example, if the IP address of the host 1 is 1.1.1.1, the IP address of the first monitoring server 201 is 1.1.1.5, IP address of the second monitoring server 202 is 1.1.3.1, the IP address of the third monitoring server 203 is 1.7.1.1, the IP address of the first monitoring server 201 is the nearest to the IP address of the host 1, the first monitoring server 201 is the first to receive the packets and also accepts the registration of the host 1.

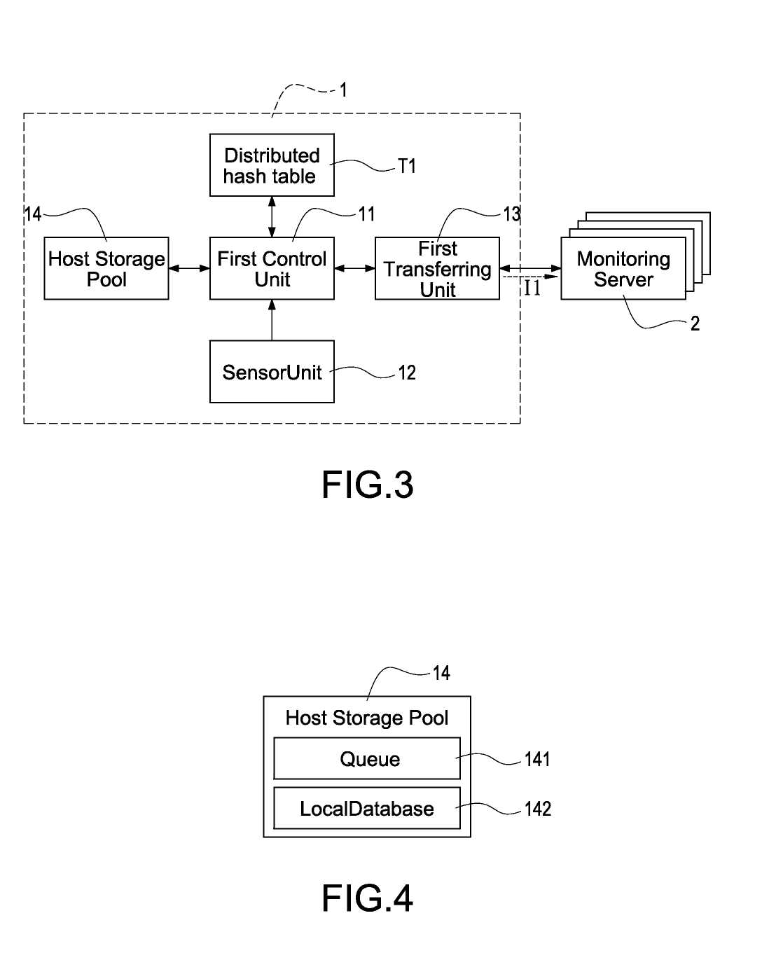

The allocation data received by the host 1 comprises a distributed hash table (the distributed hash table T1 as shown in FIG. 3) provided by the first monitoring server 201. The distributed hash table T1 respectively records corresponding categories of the plurality of monitoring servers 2. Thus, the host 1 categorizes the data of its own according to the distributed hash table T1. In addition, the host 1 respectively transfers the data to the corresponding monitoring server 2 according to the categories (step S14). In the example mentioned above, the CPU data is transferred to the first monitoring server 201, the hard drive data is transferred to the second monitoring server 202, and the network traffic data is transferred to the third monitoring server 203. In addition, when each monitoring server 2 is assigned the role, the category of the data which is monitored, saved and processed by each monitoring server 2 is also determined. Accordingly, the rules of corresponding data categories are set internally. Each monitoring server 2 receives and saves the data transferred from the host 1, and performs the following steps on the data according to the above rules (step S16).

As shown in FIG. 2, the present invention respectively monitor, save and process the data of the corresponding categories via the plurality of monitoring servers 2, which can effectively resolve the overloading issue occurred to a traditional single server or database.

FIG. 3 is a cloud host block diagram of the first preferred embodiment according to the present invention. As shown in the diagram, the host 1 comprises a first control unit 11, a sensor unit 12, a first transferring unit 13 and a host storage pool 14. The first control unit 11 connects to the sensor unit 12, the first transferring unit 13 and the host storage pool 14. The first control unit is used for processing each data of the host 1. The sensor unit 12 is used for detecting the host status of the host 1, for example CPU, memory, hard drive and network traffic etc. and in addition generating a plurality of status data I1 according to the detecting results. The plurality of status data I1 respectively records the data of different categories. For example, the host 1 generates the status data I1 of four categories, which respectively are CPU category, memory category, hard drive category and network category. In addition, the status data I1 of the four different categories is respectively transferred to the four corresponding monitoring servers 2. The status data I1 is saved by the categories via the plurality of monitoring servers 2. The status data I1 of each category can be saved by single entry or multiple entries, the quantity of the entries is not limited thereto.

The first transferring unit 13 is used for connecting to the plurality of monitoring servers 2, and transferring the status data I1, with reference to the categories, to the corresponding plurality of monitoring servers 2. The host storage pool 14 is used for temporarily saving the detected status data I1 of the sensor unit 12. As mentioned above, the host 1 internally further saves the distributed hash table T1. In addition, the distributed hash table T1 records the plurality of monitoring servers 2 respectively correspond to the status data I1 of specific categories. Thus, when the host 1 transfers the status data I1, the host 1 references the distributed hash table T1 and correctly transfers the status data I1 to the corresponding plurality of monitoring servers 2, which facilitates the plurality of monitoring servers 2 for saving the status data I1 with reference to the categories. In addition, the host 1 respectively processes the status data I1 according to the predetermined rule.

FIG. 4 is a host storage pool block diagram of the first preferred embodiment according to the present invention. As shown in the diagram, the host storage pool 14 comprises a queue 141 and a local database 142, respectively connecting to the first control unit 11. The queue 141 is used for sorting the data to be processed, and the local database 142 is used for temporarily saving the status data I1 of the host 1.

Specifically, when one of the plurality of monitoring servers 2 fails, the host 1 temporarily saves the status data of the corresponding categories I1 of the failed monitoring server 2 via the local database 142. For example, if the first monitoring server 201 is used for saving CPU related data, when the first monitoring server 201 fails, the host 1 transfers the status data I1 not related to CPU, with reference to categories, to the corresponding plurality of monitoring servers 2. The CPU data is temporarily saved in the local database 142. When the first monitoring server 201 is fixed, the host 1 transfers the data temporarily saved in the local database 142 to the first monitoring server 201. Thus, when any of the plurality of monitoring servers 2 fails, the data loss of the status data I1 of the host 1 is avoided.

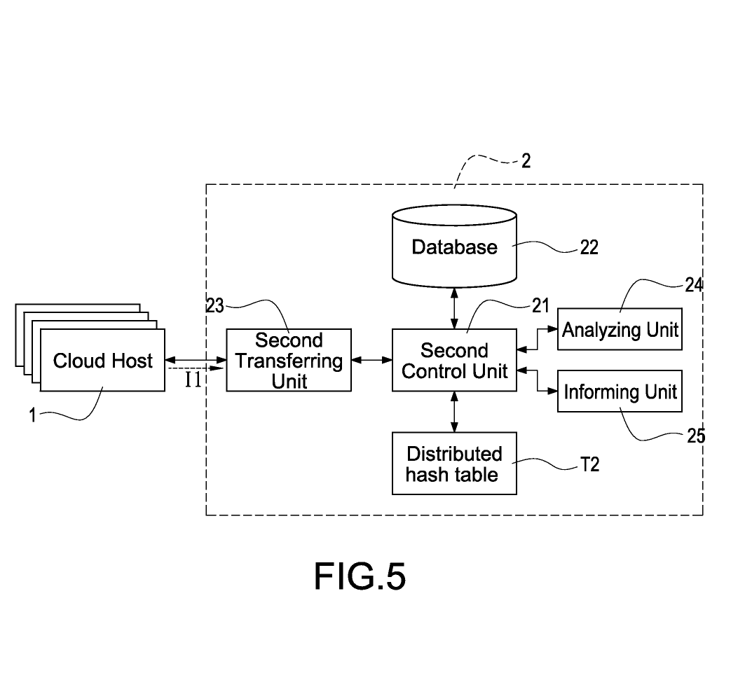

FIG. 5 is a monitoring server block diagram the first preferred embodiment according to the present invention. As shown in the diagram, the plurality of monitoring servers 2 respectively comprises a second control unit 21, a database 22, a second transferring unit 23, an analyzing unit 24 and an informing unit 25. The second control unit 21 connects to the database 22, the second transferring unit 23, the analyzing unit 24, and the informing unit 25.

The second control unit 21 is used for processing each internal data of the monitoring server 2. The second transferring unit 23 is used for connecting to the host 1, and receiving the status data of the corresponding categories I1 transferred by the host 1. The database 22 is used for saving the received status data I1 of the second transferring unit 23. Thus, in the monitoring system, additional databases are not required for saving the data of the host 1, the plurality of monitoring servers 2 are used as multiple databases.

It should be noted that the plurality of monitoring servers 2 respectively have a distributed hash table T2. In addition, the distributed hash table T2 has the same content as the distributed hash table T1 in the host 1. As mentioned above, the distributed hash table T2 records respectively corresponding categories of the plurality of monitoring servers 2, each the monitoring server 2 is informed the corresponding data categories of the other monitoring servers 2 via inquiring the distributed hash table T2. Thus, when any of the monitoring server 2 receives external inquiring requests, the monitoring server 2 is informed which monitoring server 2 has the data targeted by the external inquiring requests via inquiring the distributed hash table T2. Though, the present invention monitors, saves and processes multiple status data I1 of the host 1 via a distributed architecture, it is assured that the data-not-found issues can be avoided.

The analyzing unit 24 is used for analyzing the saved status data I1 of the database 22 for determining if the host 1 has abnormal events, specifically, the analyzing unit 24 is used for determining if an abnormal event of the corresponding categories occurred to the host 1. For example, if the second monitoring server 202 is used for monitoring related data of the hard drive, the analyzing unit 24 of the second monitoring server 202 is used for analyzing the hard drive data of the host 1, and determining if the host 1 has issues such as insufficient hard drive capacity, hard drive sector failure or data lost.

In an embodiment, each monitoring server 2 sets a predetermined threshold value according to categories. In addition, the analyzing unit 24 determines that an abnormal event occurred to the host 1 when the status data I1 exceeds the predetermined threshold value. For example, the first monitoring server 201 monitors the CPU data, and sets the temperature threshold value of the CPU as 60° C. In the embodiment, when the status data I1 indicates that the CPU temperature of the host 1 exceeds 60° C., the first monitoring server 201 determines that an abnormal event occurred to the host 1. The above example is one of the preferred embodiments of the present invention and is not limited thereto.

The informing unit 25 is used for executing an outbound informing procedure when the host 1 is determined having an abnormal event. Specifically, each monitoring server 2 presets a predetermined rule which sets the informing procedures to execute upon corresponding situations. For example, the predetermined rule sets that when the CPU temperature of the host 1 exceeds 60° C., an informing message is sent to the host 1 to instruct the host 1 to increase the fan rate. In addition, the predetermined rule sets that when the CPU temperature of the host 1 exceeds 70° C., another informing message is sent to the administrators of the monitoring system to visit onsite and resolve the abnormal issue. Nonetheless, the above examples are preferred embodiment of the present invention and are not limited thereto.

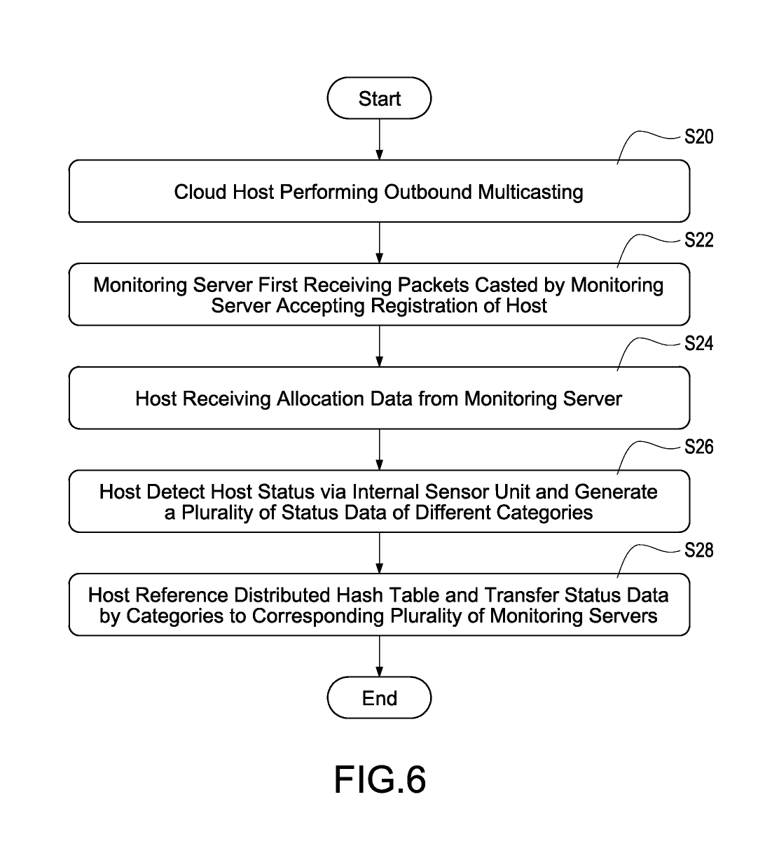

FIG. 6 is a monitoring flow chart of the first preferred embodiment according to the present invention. For implementing the monitoring method of the present invention, after the host 1 is enabled, the host 1 has to connect to the plurality of monitoring servers 2. First, the host 1 performs the outbound multicasting (step S20). Next, among the plurality of monitoring servers 2, the monitoring server 2 which first receive the packets casted by the monitoring server 2 accepts the registration of the host 1 (step S22). After the registration of the host 1 completes, the plurality of monitoring servers 2 offer service to the host 1. In addition, generally speaking, the monitoring server 2, which has the IP address nearest to the IP address of the host 1, first receives the casted packets, and accepts the registration of the host 1, the first monitoring server 201 is used as an example for illustration purpose and is not limited thereto.

When the first monitoring server 201 accepts the registration of the host 1, the host 1 receives related allocation data from the first monitoring server 201 (step S24). In addition, the allocation data includes the distributed hash table T1. After the step S24, the host 1 is informed from the distributed hash table T1 about which categories the plurality of monitoring servers 2 respectively correspond to. Accordingly, the host 1 does not need to respectively perform the registration at the other monitoring server 2.

Next, the host 1 detects the host status via the internal sensor unit 12 and generates a plurality of the status data I1 according to the detecting results. The plurality of the status data I1 respectively records the data of different categories (step S26). Lastly, the host 1 references the distributed hash table T1 and transfers the status data I1, with reference to categories, to the corresponding plurality of monitoring servers 2 (step S28). It should be noted that before the host 1 is not powered off (operating as a PM), or not deleted (operating as a VM), the host 1 continues to detect its own status, and generate the status data I1, and transfer the status data I1, with reference to categories, to the corresponding plurality of monitoring servers 2.

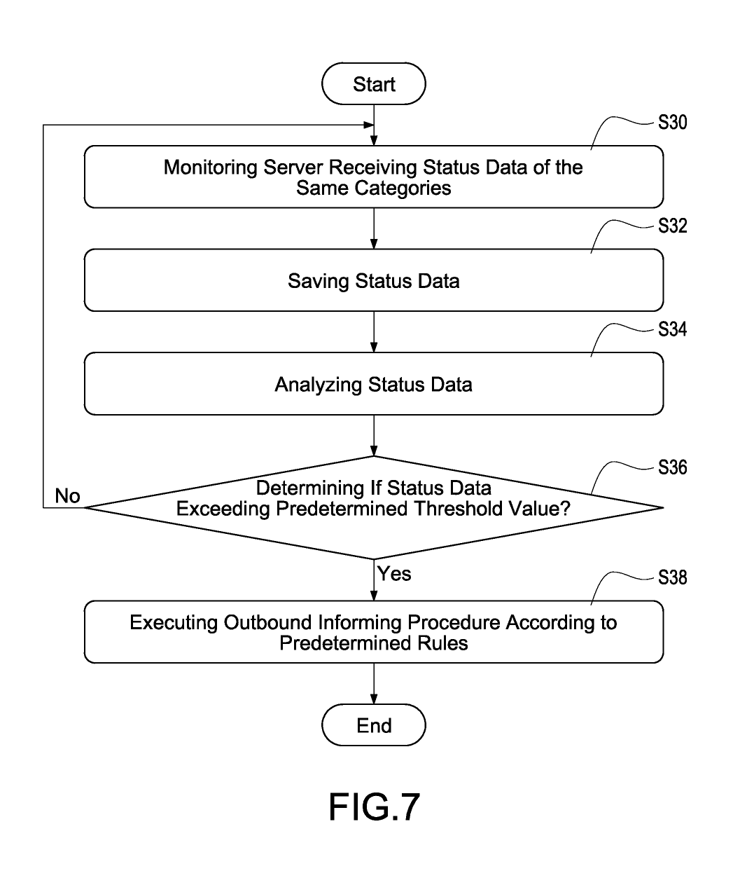

FIG. 7 is a monitoring flow chart of the second preferred embodiment according to the present invention. When the host 1 respectively transfers the status data I1 by categories, the plurality of monitoring servers 2 respectively receives the status data I1 of the categories responsible by the plurality of monitoring servers 2 (step S30). In addition, the plurality of monitoring servers 2 respectively saves the status data I1 of the same categories via the internal database 22 (step S32). Next, the flowchart analyzes the status data I1 for determining if an abnormal event occurred to the host 1 (step S34).

Specifically, each monitoring server 2 internally and respectively sets the predetermined threshold value of the above mentioned categories each is responsible for, each monitoring server 2 analyzes if the status data I1 exceeds the predetermined threshold value (step S36). In addition, when the predetermined threshold value is exceeded, an abnormal event occurred to the host 1. If there is no abnormal event detected upon analysis, the method flow moves back to the step S30, each monitoring server 2 continues to receive the status data I1 transferred from the host 1. Nonetheless, if an abnormal event occurred to the host 1 upon analysis, the monitoring server 2 executes the outbound informing procedure according to the above mentioned predetermined rules, (step S38), for directly controlling the host 1, or informing related administrators.

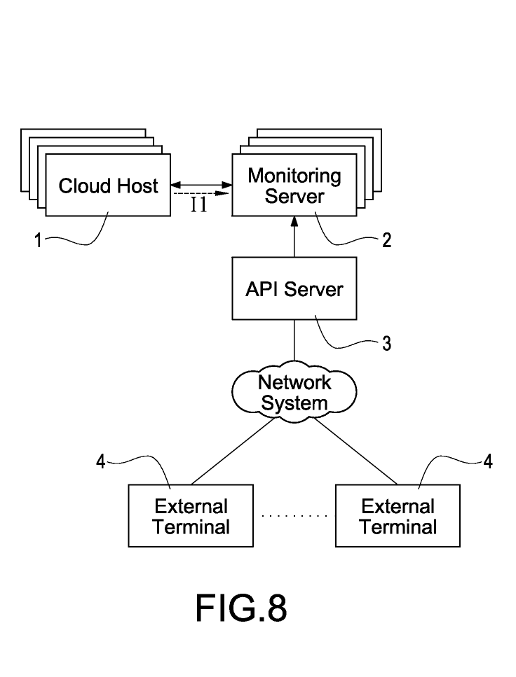

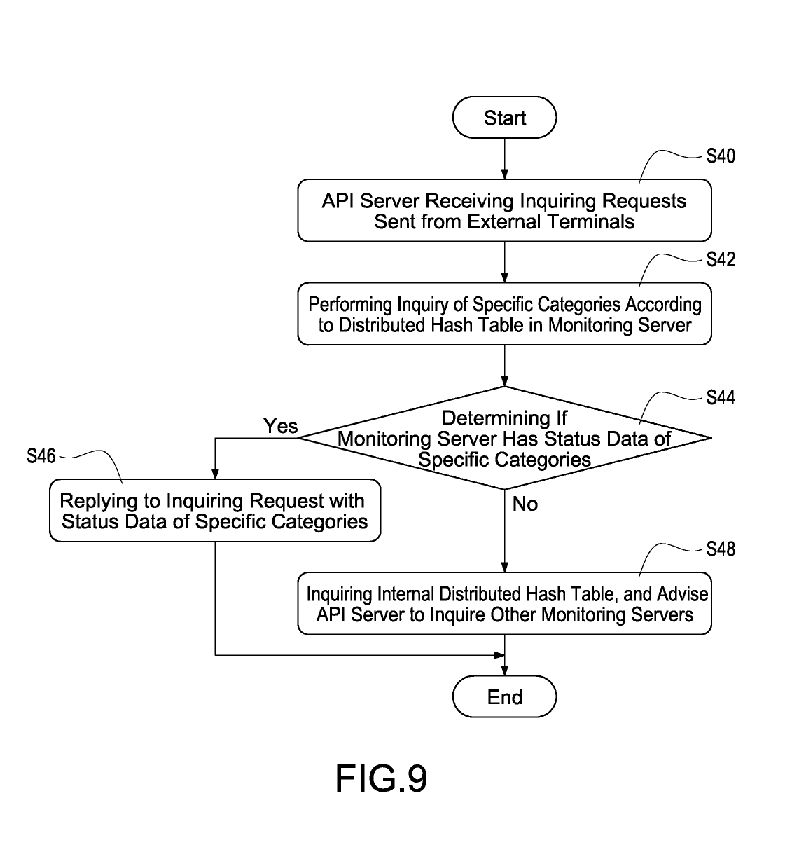

FIG. 8 is a system architecture diagram of the second preferred embodiment according to the present invention and FIG. 9 is an inquiring flow chart of the first preferred embodiment according to the present invention. As shown in FIG. 8, the monitoring system further comprises an API server 3 connecting to the plurality of monitoring servers 2. The API server 3 is an inquiring interface of the monitoring system, receiving the inquiring requests from the external terminals 4 via the network system. The API server 3 internally has the distributed hash table (not shown in the diagram). Accordingly, when the API server 3 receives the inquiring requests of the status data I1 of a specific category (for example CPU) from the external terminals 4, the API server 3 connects to the monitoring server 2 of the corresponding specific categories for performing inquiries according to the internal distributed hash table.

In the example of the third monitoring server 203, when the third monitoring server 203 receives an inquiring request, the third monitoring server 203 first determined if the third monitoring server 203 has the status data I1 of the specific categories (for example the CPU data mentioned above). If yes, the third monitoring server 203 directly replied with the internal saved status data I1 to the inquiring request. If not, the third monitoring server 203 references the distributed hash table T2, and advise the API server 3 or the external terminals 4 to search a specific monitoring server 2 having the status data I1.

Next, as shown in FIG. 9, firstly, when the user desires to inquire the status data I1 in the specific categories, the API server 3 receives the inquiring requests sent from the external terminals 4 (step S40). Next, the API server 3 connects to the monitoring server 2 of the corresponding specific categories to perform inquiry according to the distributed hash table (step S42). When the monitoring server 2 receives the inquiring request, the monitoring server 2 determines if the monitoring server 2 has the status data I1 of the specific categories (step S44). If the monitoring server 2 corresponds to the specific categories, the monitoring server 2 directly replied to the inquiring request with the status data I1 of the specific categories (step S46); if the monitoring server 2 does not correspond to the specific categories, the monitoring server 2 inquires the internal distributed hash table T2, and in addition advises the API server 3 to inquire the other monitoring servers 2 of the potential corresponding specific categories (step S48).

In the previous embodiment, each monitoring server 2 is implemented respectively by each node. In addition, each unit in the node respectively executes each task. Nonetheless, if there are too many hosts 1 in the monitoring system, for example more than ten thousands or hundreds of thousands hosts. Even each single monitoring server 2 is responsible for monitoring, saving and processing the status data I1 of single category, the overloading risk still exist. Thus, in another embodiment, the loading of each monitoring server 2 is divided and shared by multiple physical or virtual servers which collectively act as a single monitoring server 2, and reduce loading of each server.

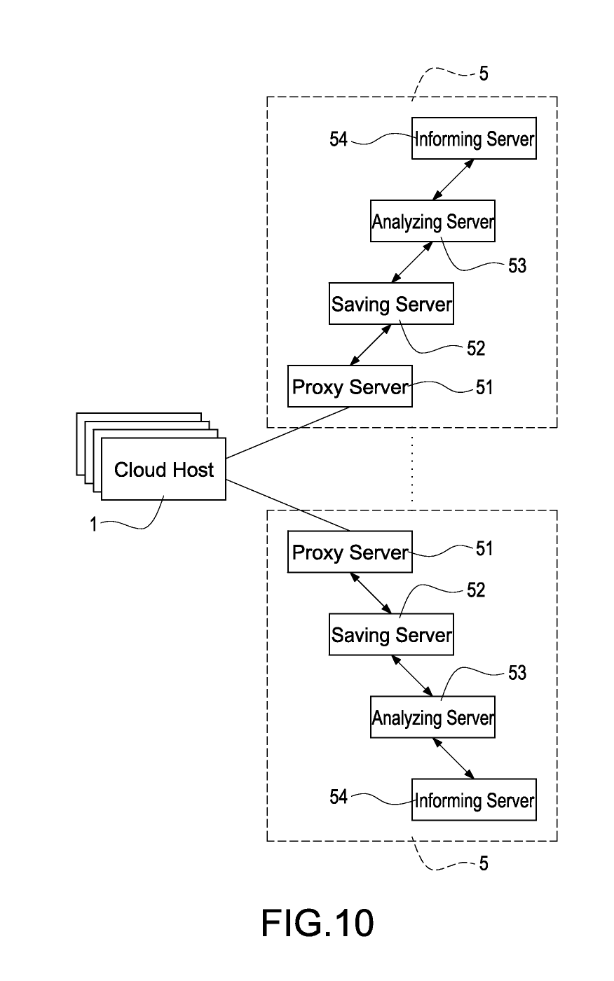

FIG. 10 is a system architecture diagram of the third preferred embodiment according to the present invention. In the embodiment, the role of a monitoring server 5 is collectively shared by several servers. As shown in the diagram, the monitoring server 5 comprises a proxy server 51, a saving server 52, an analyzing server 53 and an informing server 54. Nonetheless, four servers are used in the embodiment, the quantity of the servers are subject to field demands of the monitoring system, and is not limited thereto.

The proxy server 51 is used for connecting to the host 1, and receiving the status data of the corresponding categories I1 transferred by the host 1. The proxy server 51 is the connecting interface between the monitoring server 5 and the host 1. The saving server 52 is used for saving the proxy server 51 and the received status data I1 is used as a database of the monitoring server 5.

The analyzing server 53 has algorithm and the above mentioned predetermined threshold value which is used for analyzing the saved status data I1 saved by the saving server 52, and further determining if an abnormal event occurred to the host 1. Different analyzing server 53 has different algorithm and predetermined threshold value. Accordingly, multiple analyzing servers 53 respectively analyze the status data I1 of the different categories of the host 1. The informing server 54 is used for executing corresponding outbound informing procedure when the host 1 is determined to have an abnormal event according to the above mentioned predetermined rule. For example, the host 1 is instructed to resolve the abnormal event, or administrators are informed to arrive onsite to investigate and resolve the events.

Via the methods demonstrated in the above mentioned embodiment, the burden of the server is further distributed. For example, if the status data I1 is divided into categories, In addition, the monitoring server 5 is collectively acted by four servers. Then, in the monitoring system, there are twenty servers monitoring, saving and processing the status data I1 of the host 1. Accordingly, the single server or database is not damaged by overloading.

As the skilled person will appreciate, various changes and modifications can be made to the described embodiments. It is intended to include all such variations, modifications and equivalents which fall within the scope of the invention, as defined in the accompanying claims.

What is claimed is:

1. A monitoring system for managing cloud hosts, comprising:
a cloud host, having a sensor unit for detecting the status of the cloud hosts, and generating a plurality of status data according to the detecting results, the plurality of status data respectively recording data of different categories;
a plurality of monitoring servers, respectively connecting to the cloud hosts, each monitoring server respectively correspond to a category of the plurality of status data;
wherein, the cloud hosts transfer the plurality of status data respectively to the corresponding plurality of monitoring server according to the corresponding categories of each monitoring server, whereby the plurality of monitoring servers save the status data of the cloud hosts with reference to the categories.

2. The monitoring system of claim 1, wherein the cloud hosts has a distributed hash table, the distributed hash table recording the corresponding categories of the plurality of monitoring servers, the cloud hosts transferring the status data by the categories to the corresponding plurality of monitoring servers according to the distributed hash table.

3. The monitoring system of claim 2, wherein the cloud hosts comprises:
a first transferring unit, connecting to the plurality of monitoring servers, transfers the status data by the categories to the corresponding plurality of monitoring servers;
a host storage pool, for temporarily saving the detected status data; and
a first control unit, connecting to the first transferring unit, the host storage pool and the sensor unit for processing each data of the cloud hosts.

4. The monitoring system of claim 3, wherein the host storage pool comprising a queue and a local database, the queue performs sorting on the data to process, and when one of the plurality of monitoring servers fails the cloud hosts temporarily save the status data of the corresponding categories of the failed monitoring server via the local database.

5. The monitoring system of claim 3, wherein the plurality of monitoring servers respectively comprising:
a second transferring unit, connecting to the cloud hosts, receiving the status data of the corresponding categories transferred from the cloud hosts;
a database, saving the received status data; and
a second control unit, connecting to the second transferring unit and the database, processing each data of the monitoring server.

6. The monitoring system of claim 5, wherein the plurality of monitoring servers respectively comprises the distributed hash table, when one of the plurality of monitoring servers accepts registrations of the cloud hosts the distributed hash table is transferred to the cloud host.

7. The monitoring system of claim 6, wherein the plurality of monitoring servers respectively comprising:
an analyzing unit, connecting to the second control unit, analyzing the saved status data, determining if an abnormal event occurred to the cloud hosts; and
an informing unit, connecting to the second control unit, when an abnormal event occurred to the cloud hosts, an outbound informing procedure is executed according to a predetermined rule.

8. The monitoring system of claim 7, wherein further comprises a Application Programming Interface (API) server connecting to the plurality of monitoring servers and having the distributed hash table, when the API monitoring server receives inquiring requests of the status data in a specific category from external terminals, the API monitoring server performs inquiring with the monitoring server of the corresponding specific categories according to the distributed hash table.

9. The monitoring system of claim 3, wherein the plurality of monitoring servers respectively comprising:
a proxy server, connecting to the cloud hosts, receiving the status data of the corresponding categories transferred from the cloud hosts;
a saving server, saving the received status data by the proxy server;
an analyzing server, analyzing the saved status data, determining if an abnormal event occurred to the cloud hosts; and
an informing server, when an abnormal event occurred to the cloud hosts, an outbound informing procedure is executed according to a predetermined rule.

10. A monitoring method for managing cloud hosts, comprising:
a) a cloud host detecting its own status, and generating a plurality of status data, wherein the plurality of status data respectively records data of different categories;
b) the cloud host connecting the cloud host to a plurality of monitoring servers, wherein each monitoring server respectively correspond to a category of the status data;
c) the cloud host transferring the status data of the cloud host by the categories to the corresponding plurality of monitoring servers according to the corresponding categories of each monitoring server.

11. The monitoring method of claim 10, wherein the method comprises the following steps before step a:
a01) the cloud hosts performing the outbound multicast;
a02) the monitoring server first receiving the casted packets from the cloud hosts accepting registration of the cloud hosts;
a03) transferring a distributed hash table to the cloud hosts completed the registration, wherein the distributed hash table records the corresponding categories of the plurality of monitoring servers.

12. The monitoring method of claim 11, wherein in the step a02, the monitoring servers of the plurality of monitoring servers which have the IP address nearest to the IP addresses of the cloud hosts first receive the packets. Note: single or plural??

13. The monitoring method of claim 10, wherein the method further comprises the following steps:
d) the plurality of monitoring servers respectively receiving the status data of the corresponding categories;
e) saving the status data;
f) analyzing the status data, and determining if an abnormal event occurred to the cloud hosts; and
g) when an abnormal event occurred to the cloud hosts, an outbound informing procedure is executed according to a predetermined rule.

14. The monitoring method of claim 13, wherein the plurality of monitoring servers respectively set a predetermined threshold value based on corresponding categories, and the step f comprises:
f1) analyzing if the status data exceeds the predetermined threshold value; and
f2) when the status data exceeds the predetermined threshold value an abnormal event occurred to the cloud hosts.

15. The monitoring method of claim 10, wherein further comprising following step:
h) one of the plurality of monitoring servers receiving the inquiring requests of the status data in a specific category;
i) determining if the monitoring server saves the status data of the specific categories;
j) if the status data of the specific categories is saved in the monitoring server, the inquiring requests are replied according to the status data; and
k) if the status data of the specific categories is not saved in the monitoring server, the monitoring server inquires a distributed hash table, and sends advice to the external terminals made the inquiring requests to inquire other monitoring servers, wherein the distributed hash table records the corresponding categories of the plurality of monitoring servers.

16. A monitoring system for managing cloud hosts, comprising:
a plurality of monitoring servers, respectively and correspondingly processing data of different categories, each monitoring server respectively having a distributed hash table, recording the corresponding categories of each monitoring server; and
a cloud host, connecting to the plurality of monitoring servers, the cloud hosts having a sensor unit for detecting the status of the cloud hosts, and generating a plurality of status data according to the detecting results, wherein the plurality of status data respectively recording data of different categories;
wherein, the cloud hosts receive the distributed hash table from one of the plurality of monitoring servers, and respectively transfer the plurality of status data by the categories to the corresponding plurality of monitoring servers according to the distributed hash table, whereby the plurality of monitoring servers saves the status data of the cloud hosts by the categories.

17. The monitoring system of claim 16, wherein further comprising an API server connecting to the plurality of monitoring servers, and has the distributed hash table, when the API monitoring server receives inquiring requests of the status data in a specific category from external terminals, the API monitoring server performs inquiring with the monitoring server of the corresponding specific categories according to the distributed hash table.

18. The monitoring system of claim 16, wherein the cloud hosts comprising:
a first transferring unit, connecting to the plurality of monitoring servers, transfers the status data by the categories to the corresponding plurality of monitoring servers;
a queue, performing sorting on the status data to process;
a local database, when one of the plurality of monitoring servers fails, the status data of the corresponding categories of the failed monitoring server is temporarily saved; and
a first control unit, connecting to the first transferring unit, the queue, the local database and the sensor unit, processing each data of the cloud hosts.

19. The monitoring system of claim 16, wherein the plurality of monitoring servers respectively comprises:
a second transferring unit, connecting to the cloud hosts, receiving the status data of the corresponding categories transferred from the cloud hosts;
a database, saving the received status data;
an analyzing unit, analyzing the saved status data, determining if an abnormal event occurred to the cloud hosts;
an informing unit, when an abnormal event occurred to the cloud hosts, an outbound informing procedure is executed according to a predetermined rule; and
a second control unit, connecting to the second transferring unit, the database, the analyzing unit and the informing unit, processing each data of the monitoring server.

20. The monitoring system of claim 16, wherein the plurality of monitoring servers respectively comprises:
a proxy server, connecting to the cloud hosts, receiving the status data of the corresponding categories transferred from the cloud hosts;
a saving server, saving the received status data by the proxy server;
an analyzing server, analyzing the saved status data, determining if an abnormal event occurred to the cloud hosts; and
an informing server, when an abnormal event occurred to the cloud hosts, an outbound informing procedure is executed according to a predetermined rule.
